(19) United States
(12) Patent Application Publication
(10) Pub. No.: US 2008/0018035 A1
(43) Pub. Date: Jan. 24, 2008

(54) Damper Unit For A Vehicle Suspension System

(76) Inventors: Christopher Anthony Porter, Monmouth (GB); Rowan John Smith, Pontypool (GB)

Correspondence Address: Fildes & Outland, 20916 Mack Avenue, Suite 2, Grosse Pointe Woods, MI, 48236, US

(21) Appl. No.: 11/547,465

(22) PCT Filed: Apr. 1, 2005
(86) PCT No.: PCT/GB05/01257

§ 371 Date: May 25, 2007

(30) Foreign Application Priority Data
Apr. 8, 2004 (GB) 0408065.1

(51) Int. Cl. F16F 9/44

(52) U.S. Cl. 267/218; 267/217

(57) ABSTRACT

A damper (328) for a vehicle suspension system comprising a chamber (338) in which a piston assembly (330) is movable, the piston assembly (330) dividing the chamber (338) into first, second and third volumes (338a, 338b, 338c); the damper including a first compression fluid flow circuit affording fluid communication from the first volume (3380) to the second volume (338b) on a compression stroke of the piston assembly (330), a second compression fluid flow circuit in series with the first fluid flow circuit, the second compression fluid flow circuit affording fluid communication from the second volume (338b) to the third volume (338c) on the compression stroke, wherein one of the first and second compression fluid flow circuits has a flow resistance greater than that of the other of said first and second compression fluid flow circuits.

The present invention relates to a damper unit for a vehicle suspension system and particularly, but not exclusively, to a damper unit for a shock absorber of a front or rear suspension system for a single-track vehicle such as a bicycle or a motorcycle (hereinafter collectively referred to as “cycles”) having adjustable rebound damping or separately adjustable rebound and compression damping.

Front and rear mounted suspension systems are common to almost all types of motorcycles and also to bicycles designed for off-road use (commonly referred to as “mountain bikes”). There are many different types of such front and rear mounted suspension systems. The most common arrangement of a front mounted suspension system for a cycle is the telescoping front fork system. In the case of a rear mounted suspension system for a cycle, the most common arrangement comprises a spring/damper assembly actuated by a linkage driven directly by a swing-arm to which the rear cycle wheel is attached.

The primary function of a front and/or rear mounted suspension system is to allow the wheels (or tracks or sleds) of a vehicle (un-sprung mass) to track the undulations of the ground whilst isolating the rider/driver (sprung mass), or passenger compartment in the case of large vehicles, from shocks received by the wheels when travelling over rough terrain. In the absence of a suspension system, the shocks received by the wheels are transferred to the rider/driver through the vehicle chassis. This can reduce the amount of control the rider/driver has of the vehicle over rough terrain because of his discomfort. A rigid un-suspended chassis can affect ability of the rider/driver to steer, brake and power the vehicle over rough terrain because of the intermittent loss of contact with the ground resulting from the vehicle being bumped into the air.

Even on a smooth surface, braking and accelerating forces create fore to aft weight shifts in all vehicles, both single-tracked such as cycles and twin-tracked such as four or more wheeled vehicles. For twin-tracked vehicles, steering also creates sideways weight shifts. Any weight shifts on a suspended chassis vehicle will affect the response of the suspension system to shocks received by the wheels. Consequently, the suspension system of a vehicle must achieve a balance between allowing the wheels to move sufficiently with respect to the chassis to absorb bumps and track undulations over rough terrain and yet keep the vehicle relatively stable during hard braking, steering and accelerating. A damper unit is a part of a vehicle's suspension system that primarily performs this function.

The damper unit is preferably arranged such that it can differentiate between “high speed” damping forces typically encountered on rough terrain and “low speed” damping forces typically resulting from braking, steering and accelerating by employing “demand” valves. In cycles, a rider can exert a “low speed” force on the suspension system damper unit(s) by shifting his weight with respect to the cycle chassis through standing, sitting and/or sliding backwards or forwards. Also, bicycles have another low speed damping force to deal with resulting from the movement of the rider's legs when powering the bicycle. The terms “high speed” and “low speed” as used herein will be familiar to a skilled artisan as pertaining not to the speed of the vehicle over the terrain but to the damping characteristics of the suspension system.

A conventional damper unit for a cycle suspension system is mounted between the cycle chassis and a wheel mounting assembly such that the damper unit acts to dampen relative movement of the chassis with respect to the wheel mounting assembly. One such conventional damper unit includes a damper piston fixedly mounted on a damper shaft, the damper piston being movable within an oil filled chamber. The unit includes a spring for supporting the sprung mass and for returning the unit to its at rest position following a compression stroke of the piston. The piston includes compression stroke and rebound stroke demand valves. These allow oil to flow through ports connecting one side of the damper piston to the other on respective compression and rebound strokes of the piston in response to changes in oil pressure levels resulting from movement of the piston in the oil filled chamber.

The demand valves each comprise a stack of normally circular, flexible steel, leaf spring shims which deflect away from the piston to open their respective ports. The amount by which the shims deflect and therefore the speed of oil through a respective fluid circuit comprising a shim stack and its associated port(s) is dependent on the pressure of oil exerted on the shims. Thus, the shim stacks control the demand for oil flow through the piston dependent on the pressure of oil exerted on them.

The piston includes a free bleed port which, when open, allows oil to flow more freely through the piston thereby by-passing the compression and rebound demand valve fluid circuits. The degree to which the free bleed port is open is adjustable. This adjustment is commonly referred to as the “low speed rebound” adjustment even though the free bleed port allows for oil flow on the compression stroke when the free bleed port is open.

The damper unit includes a static compression stroke demand valve comprising a piston which is fixedly secured in position in a lower part of the chamber. The static piston is arranged such that oil displaced on the compression stoke by the damper shaft flows through a compression stroke shim stack of the static piston but returns via a check valve on the rebound stroke offering little or no flow resistance to returning oil. The static piston includes a bleed port by-passing the static piston compression shim stack. The degree to which this port is open is adjustable and this adjustment is commonly referred to as the “low speed compression” adjustment.

When designing and assembling a cycle suspension system, a manufacturer normally configures the suspension system to suit a rider of mean average weight. The damper unit return spring is pre-loaded as a standard setting to provide a certain amount of sag under load for a rider of mean average weight. The degree of pre-loading is normally adjustable within a certain range to compensate for riders of weights spanning a range either side of the mean average. However, for a rider who is much heavier than the mean average weight, the degree of sag will exceed the manufacturer's preferred limit. In such a case, a stiffer return spring should be utilised. The converse is true for a rider who is much lighter than the mean average weight. Alternatively, a rider may choose a spring of a certain stiffness to suit an intended riding style.

In a like manner to the selection of the spring stiffness, for the damping circuits, settings in the middle of their adjustment ranges are utilised for both the rebound and compression adjustments for a rider of mean average weight and/or a moderate riding style. However, slower rebound and compression settings, i.e. bleed ports more closed than open, are selected for a damper unit utilising a stiffer spring for a heavier than average rider and/or for a harder riding style and softer (faster) settings selected for a damper unit having a less stiff spring for a lighter than average rider and/or a softer riding style.

A demand valve shim stack can be arranged in an almost infinite numbers of ways through the selection of different numbers of shims of different diameters and thicknesses. It is therefore possible to arrange a shim stack to control oil flow through a demand valve circuit in a manner that best addresses prevailing circumstances such as return spring stiffness, type of terrain, preferred riding style, type of cycle, weight of rider etc. However, the aim is to get as much of the oil flow as possible through the shim stacks since these control flow according to demand. Any oil flowing through the bleed ports is not controlled in accordance with demand which is undesirable. This is particularly the case where the low speed rebound adjuster on the damper piston is anything but fully closed since oil flow on the compression stroke is also affected creating a low speed bleed which by-passes the damper piston compression shim stack causing excessive movement of the suspension under braking, accelerating and weight shift “low-speed” forces.

It is common practice for cycle riders participating in competitions, for example, to select a return spring of certain stiffness and rearrange the shim stacks of the demand valves in an attempt to obtain optimum performance of the damper unit for the prevailing conditions of preferred riding style, terrain type, etc. However, this is a complex process requiring a considerable amount of trial and error requiring complete dismantling and reassembly of the damper unit for each new combination of spring and/or shim stack rearrangement until a satisfactory result is found and, therefore, is not practicable for most riders.

The present invention provides a damper unit for a vehicle suspension system that obviates and/or mitigates disadvantages associated with conventional suspension system damper units, particularly with regard to the adjustment of rebound and compression damping.

Accordingly, in a first aspect the present invention provides a damper for a vehicle suspension system comprising a chamber in which a piston assembly is movable, the piston assembly dividing the chamber into first, second and third volumes; the damper including a first compression fluid flow circuit affording fluid communication from the first volume to the second volume on a compression stroke of the piston assembly, a second compression fluid flow circuit in series with said first fluid flow circuit, said second compression fluid flow circuit affording fluid communication from the second volume to the third volume on said compression stroke, wherein one of said first and second compression fluid flow circuits has a flow resistance greater than that of the other of said first and second compression fluid flow circuits.

Preferably, the flow resistance of the first compression fluid flow circuit is greater than the flow resistance of the second compression fluid flow circuit.

Preferably, the flow resistance of the first compression fluid flow circuit is substantially greater than the flow resistance of the second compression fluid flow circuit.

Alternatively, the flow resistance of the second compression fluid flow circuit is greater than the flow resistance of the first compression fluid flow circuit.

Consequently, in the damper arrangement of the present invention, damping on the compression stroke is controlled by at least the flow resistance characteristic of the compression fluid flow circuit having the greater flow resistance.

Preferably, the damper includes a first rebound fluid flow circuit affording fluid communication from the third volume to the second volume on a rebound stroke of the piston assembly and a second rebound fluid flow circuit in series with said first rebound fluid flow circuit, said second rebound fluid flow circuit affording fluid communication from the second volume to the first volume on said rebound stroke.

Preferably also, the first rebound fluid flow circuit has a flow resistance greater than that of the second rebound fluid flow circuit.

Alternatively, the second rebound fluid flow circuit has a flow resistance greater than that of the first rebound fluid flow circuit.

Preferably further, the damper of the present invention includes a by-pass fluid flow circuit in parallel with a lighter of the two compression fluid flow circuits and a heavier of the two rebound fluid flow circuits, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the lighter of the two compression fluid flow circuits and the heavier of the two rebound fluid flow circuits on respective compression and rebound strokes of the piston assembly.

The by-pass fluid flow circuit may be provided in parallel with both the second compression fluid flow circuit and the first rebound fluid flow circuit where said second compression fluid flow circuit has a flow resistance less than that of the first fluid flow circuit and said first rebound fluid flow circuit has a flow resistance greater than that of the second rebound fluid flow circuit, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the second compression fluid flow circuit and the first rebound fluid flow circuit on respective compression and rebound strokes of the piston assembly.

Alternatively, the by-pass fluid flow circuit is provided in parallel with both the first compression fluid flow circuit and the second rebound fluid flow circuit where said first compression fluid flow circuit has a flow resistance less than that of the second fluid flow circuit and said second rebound fluid flow circuit has a flow resistance greater than that of the first rebound fluid flow circuit, wherein said fluid flow control means is operable to open or close said by-pass fluid flow circuit such that, when the fluid flow control means is operated to be open, the by-pass fluid flow circuit enables a portion of the fluid flow to by-pass the first compression fluid flow circuit and the second rebound fluid flow circuit on respective compression and rebound strokes of the piston assembly.

Preferably also, the fluid flow control means is adjustable to occupy any position between open and closed positions thereof in order to vary the portion of the fluid flow allowed to flow through said by-pass fluid flow circuit on compression and rebound strokes of the piston assembly.

The ability to adjust the degree to which the by-pass fluid flow circuit is open to allow a portion of the fluid to by-pass the rebound flow circuit having the greater flow resistance provides a means of adjusting the whole rebound damping characteristic of the damper, for both high speed and low speed damping characteristics.

Advantageously, the rebound damping characteristic is adjustable in a wide range through the ability to adjust the degree to which the by-pass fluid flow circuit is open thereby by-passing the “heavier” of the two rebound fluid flow circuits whereas the corresponding change in the compression stroke damping characteristic is barely noticeable because the by-pass fluid flow circuit only by-passes the “lighter” of the two compression fluid flow circuits which provides virtually no resistance to fluid flow. anyway

Preferably, the first and second compression fluid flow circuits respectively comprise first and second compression stroke demand valves.

Preferably also, the first and second rebound fluid flow circuits respectively comprise first and second rebound stroke demand valves.

Preferably also, the by-pass fluid flow circuit comprises a passage through a piston or mounting bolt of a piston element.

Preferably further, the vehicle is a cycle.

According to a second aspect of the present invention, there is provided a shock absorber for a vehicle including a damper in accordance with the appended claims.

According to a third aspect of the present invention, there is provided a suspension system for a vehicle in accordance with the appended claims.

According to a fourth aspect of the present invention, there is provided a suspension system for a cycle including a damper in accordance with the appended claims.

According to a fifth aspect of the present invention, there is provided a cycle including a suspension system in accordance with the appended claims.

The foregoing and further features of the present invention will be more readily understood from the following description of a preferred embodiment thereof, by way of example, and with reference to the accompanying drawings of which:

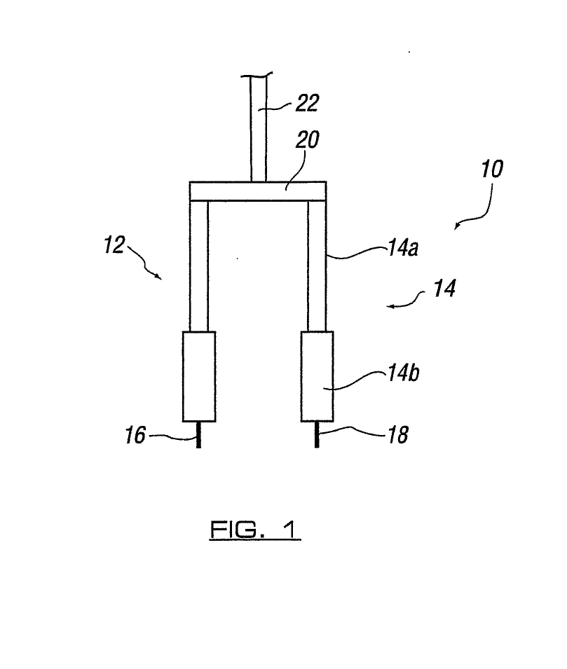

FIG. 1 is a schematic illustration of a conventional front fork assembly for a cycle;

FIG. 2 is an enlarged sectional view in schematic form and not to scale of a fork leg comprising part of the conventional front fork assembly of FIG. 1;

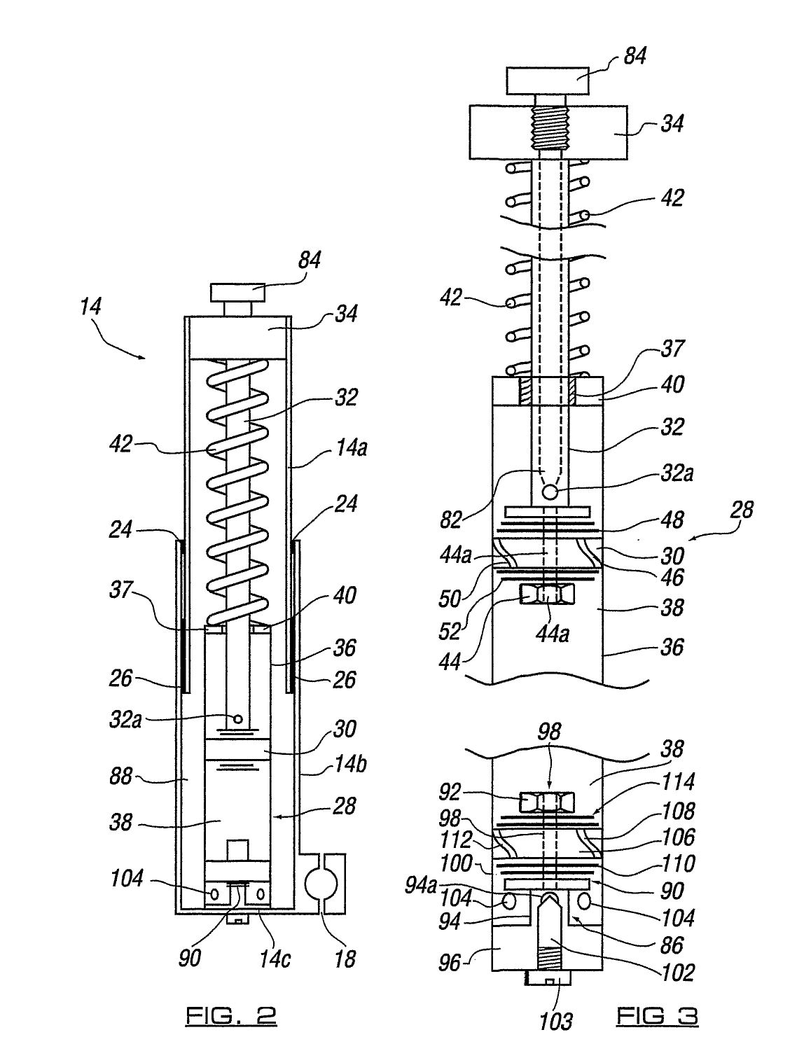

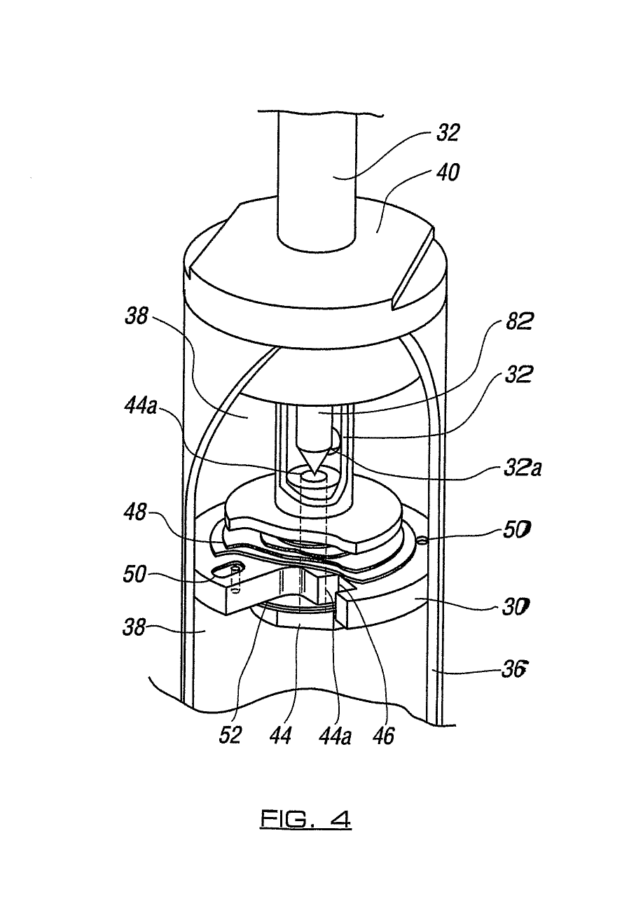

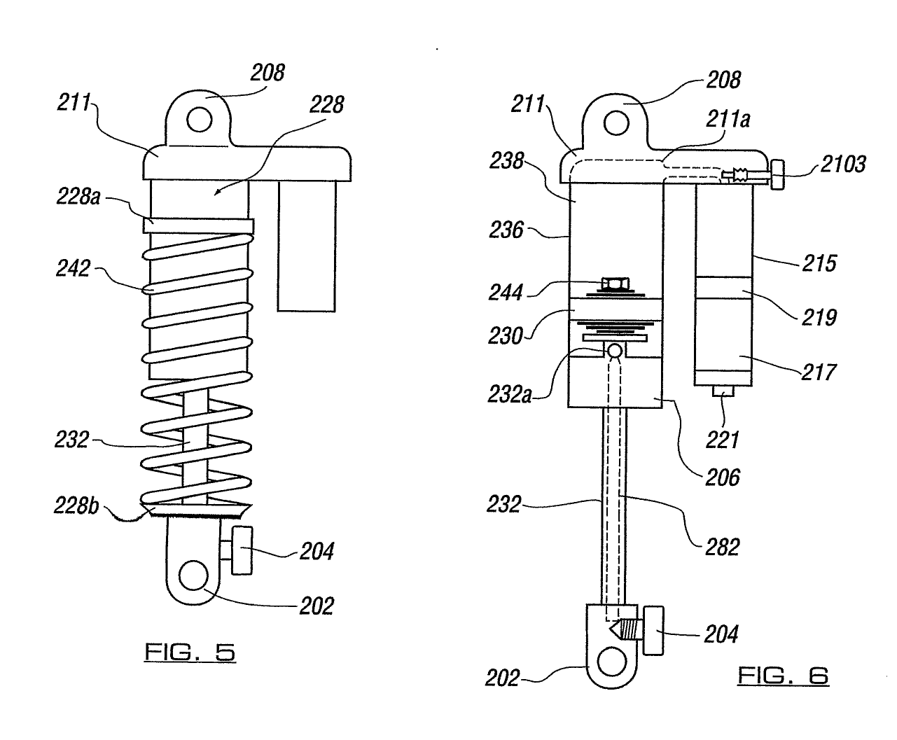

FIG. 3 is a more enlarged sectional view in schematic form and not to scale of the major internal parts of the fork leg depicted in FIG. 2;

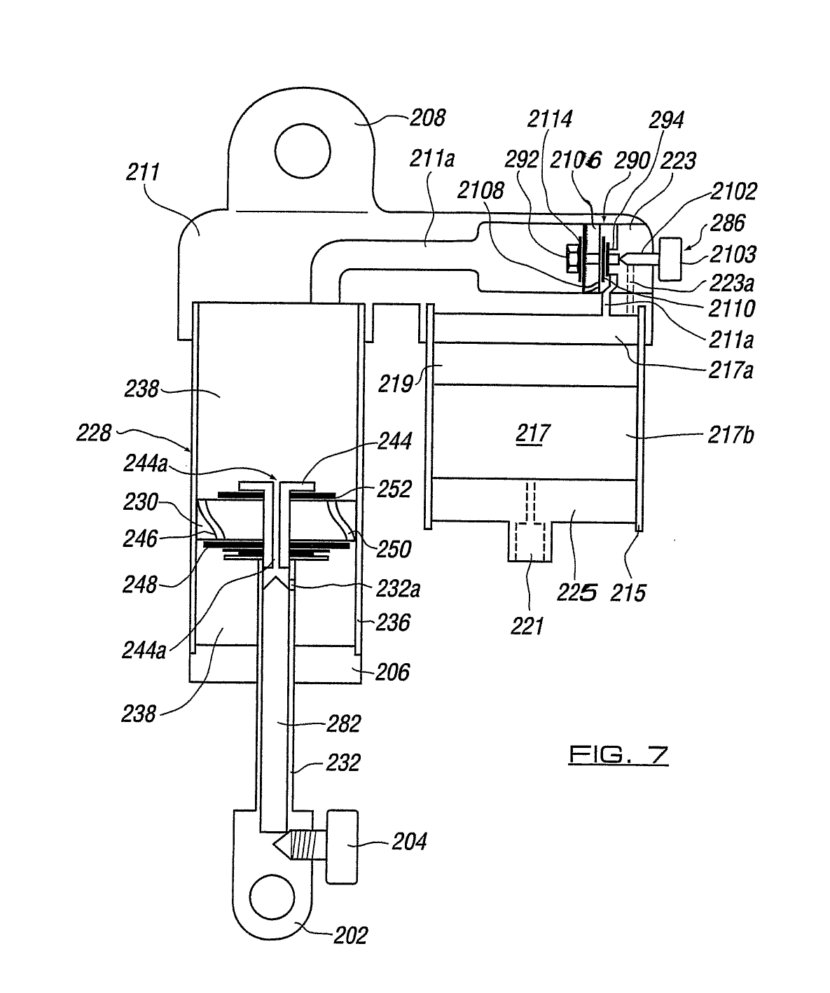

FIG. 4 is an enlarged cutaway perspective view in schematic form and not to scale of a top portion of a damper assembly cartridge of the fork leg depicted in FIG. 2;

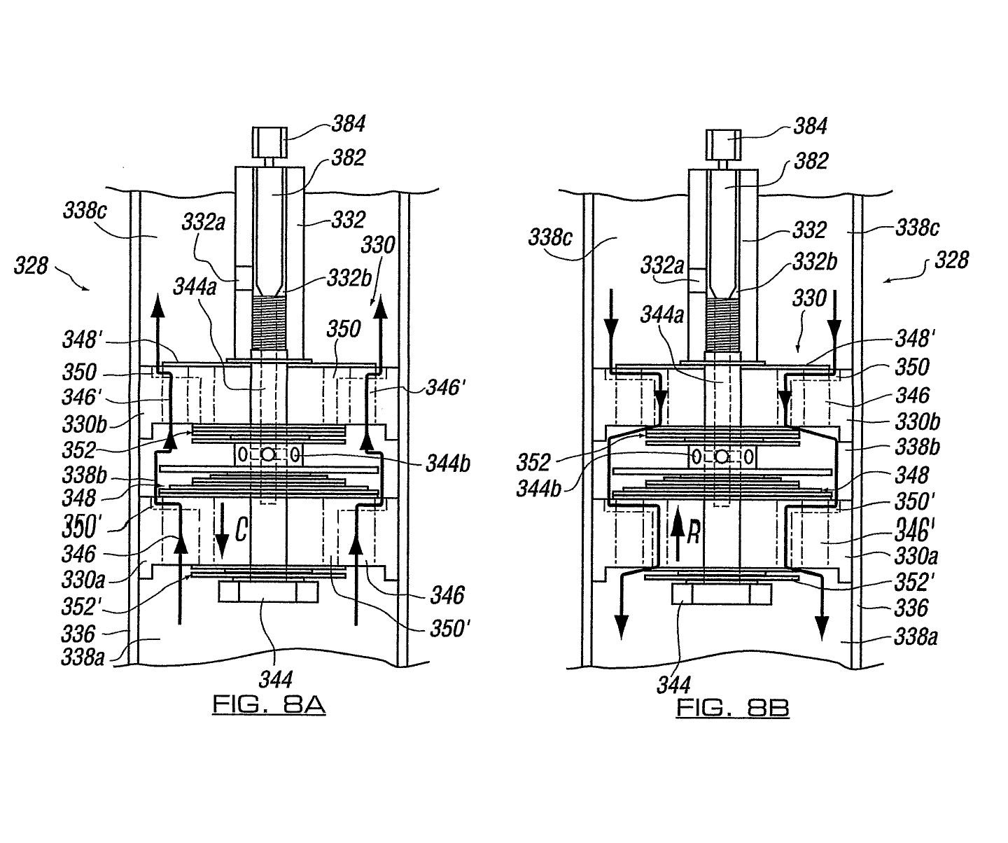

FIG. 5 is a side elevation view in schematic form of a conventional damper unit for a rear suspension system for a cycle;

FIG. 6 is a side sectional view in schematic form and not to scale of the conventional rear damper unit depicted in FIG. 5;

FIG. 7 is a more enlarged side sectional view in schematic form and not to scale of the conventional rear damper unit depicted in FIG. 5;

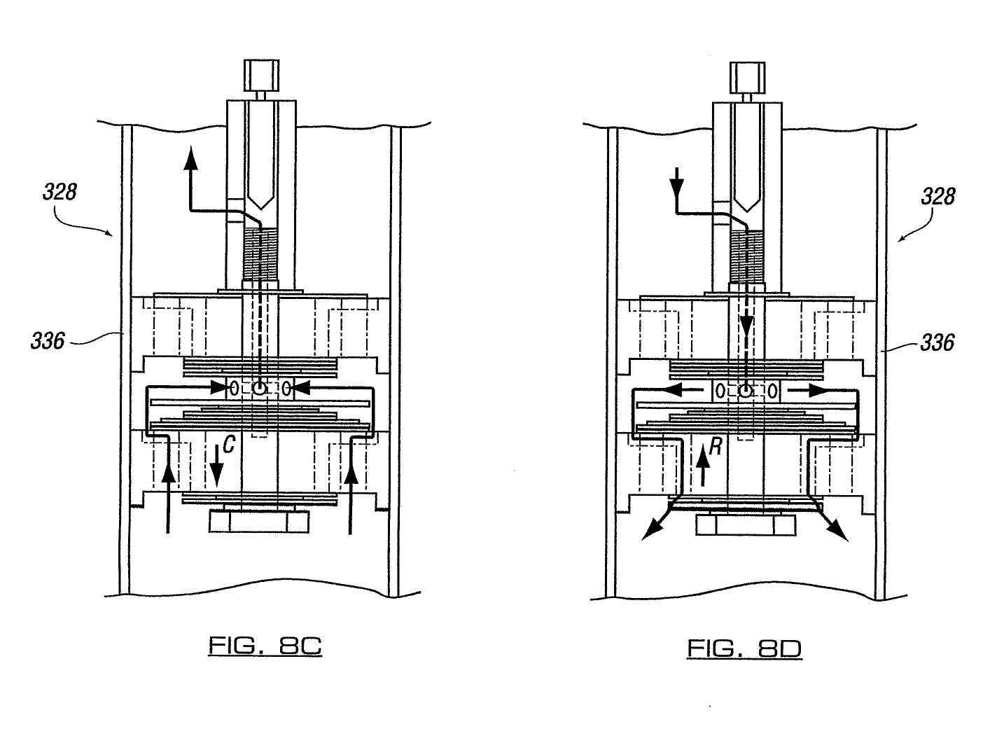

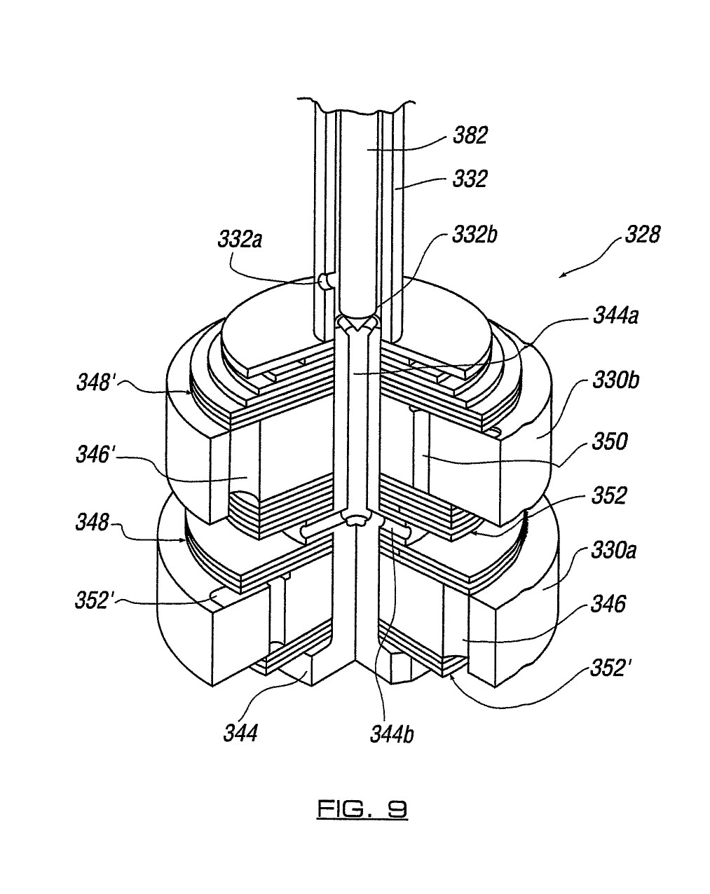

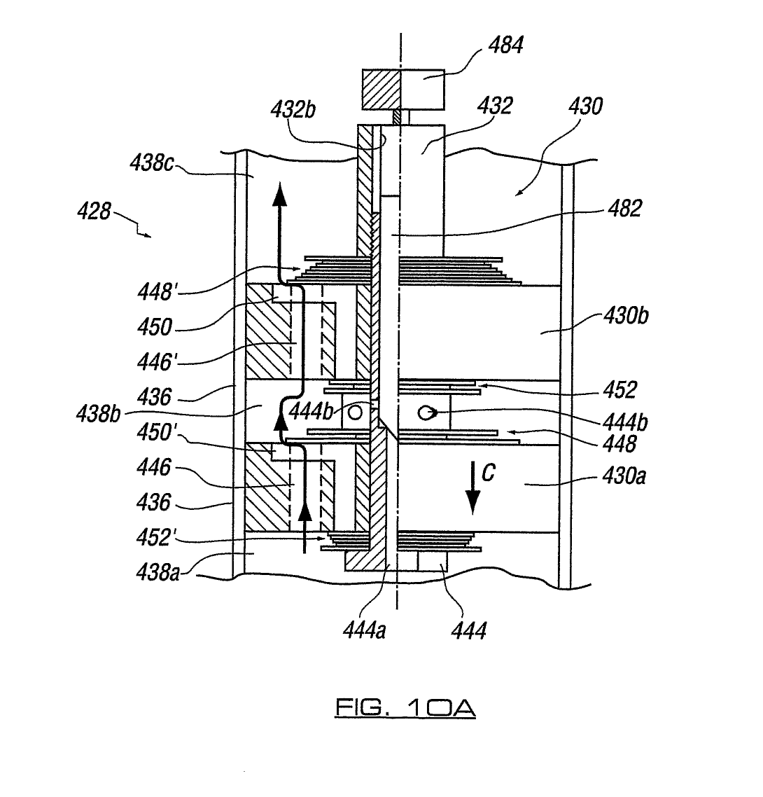

FIG. 8a is a side sectional view in schematic form and not to scale of a truncated section of a novel damper assembly in accordance with a first embodiment of the present invention with a by-pass valve in its closed position illustrating fluid flow on a compression stroke;

FIG. 8b is a side sectional view in schematic form and not to scale of a truncated section of a novel damper assembly in accordance with a first embodiment of the present invention with a by-pass valve in its closed position illustrating fluid flow on a rebound stroke;

FIG. 8c is a side sectional view in schematic form and not to scale of a truncated section of a novel damper assembly in accordance with a first embodiment of the present invention with a by-pass valve in its open position illustrating fluid flow on a compression stroke;

FIG. 8d is a side sectional view in schematic form and not to scale of a truncated section of a novel damper assembly in accordance with a first embodiment of the present invention with a by-pass valve in its open position illustrating fluid flow on a rebound stroke;

FIG. 9 is an enlarged cutaway perspective view in schematic form and not to scale of a damper piston assembly for the damper assembly in accordance with a first embodiment of the invention;

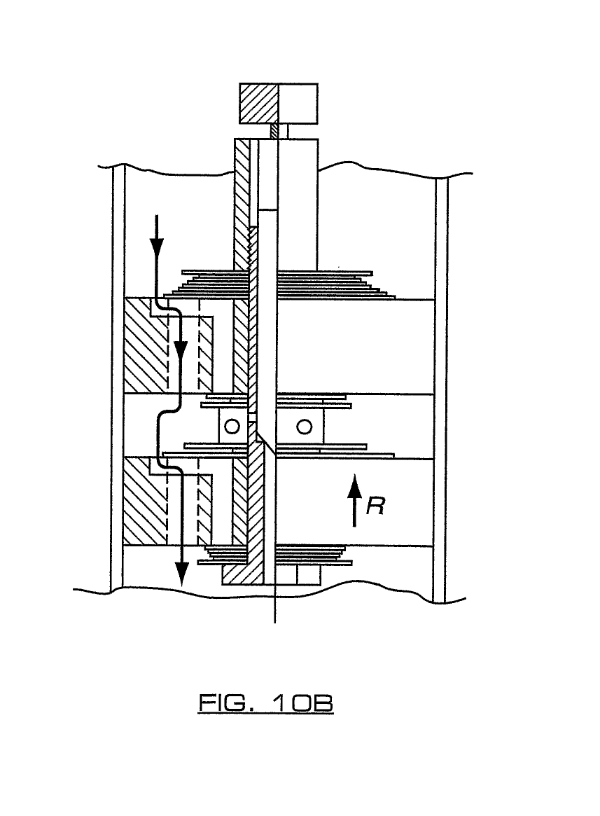

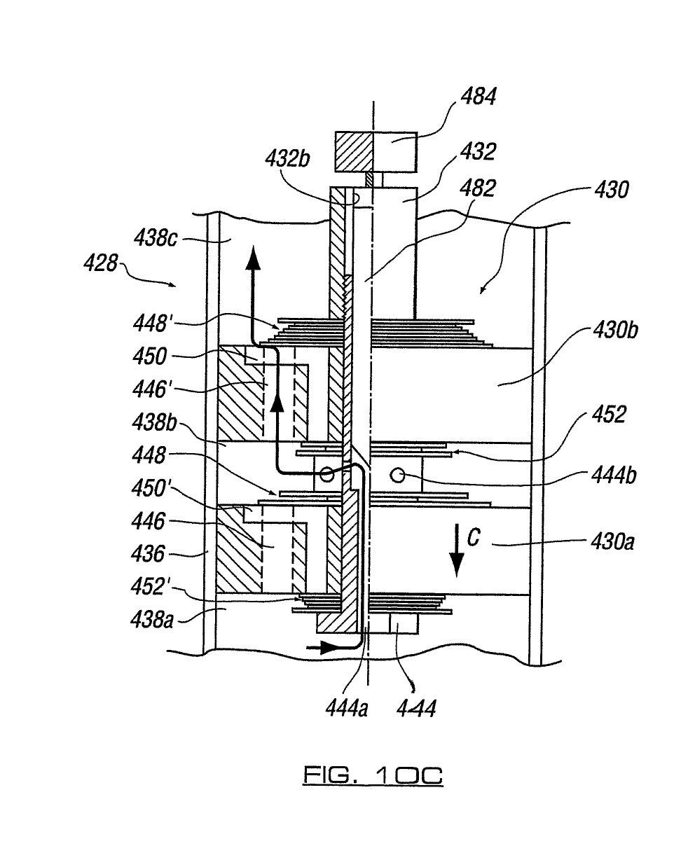

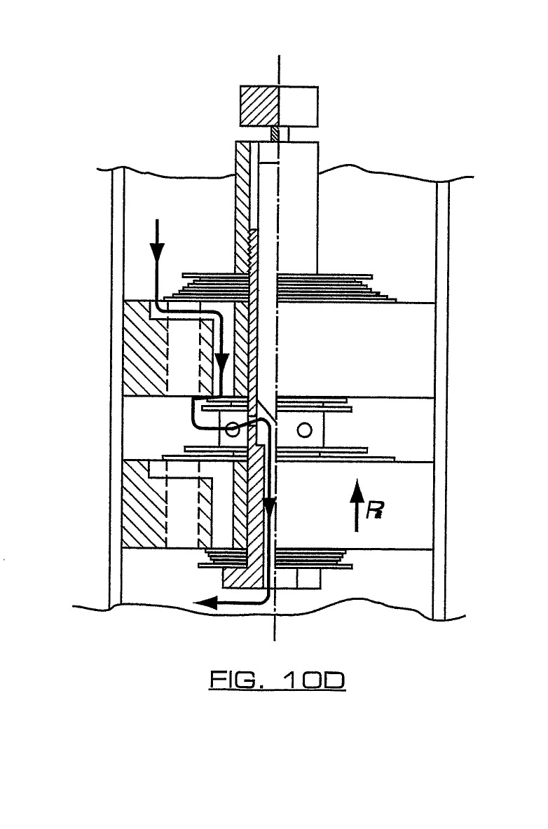

FIG. 10a is a side sectional view in schematic form and not to scale of a truncated section of a novel damper assembly in accordance with a second embodiment of the present invention with a by-pass valve in its closed position illustrating fluid flow on a compression stroke;

FIG. 10b is a side sectional view in schematic form and not to scale of a truncated section of a novel damper assembly in accordance with a second embodiment of the present invention with a by-pass valve in its closed position illustrating fluid flow on a rebound stroke;

FIG. 10c is a side sectional view in schematic form and not to scale of a truncated section of a novel damper assembly in accordance with a second embodiment of the present invention with a by-pass valve in its open position illustrating fluid flow on a compression stroke; and

FIG. 10d is a side sectional view in schematic form and not to scale of a truncated section of a novel damper assembly in accordance with a second embodiment of the present invention with a by-pass valve in its open position illustrating fluid flow on a rebound stroke.

Referring to FIGS. 1 to 4, shown is a conventional front fork suspension system for cycles comprising a known type of un-pressurised, oil circulating damper unit with compression and rebound adjustment facility.

FIG. 1 schematically illustrates the structure of a front fork assembly 10 of a cycle (not shown). The front fork assembly 10 comprises a pair of fork legs 12, 14 each having at its lower end (relative to the normal orientation of the cycle) a respective wheel attachment mount 16, 18 for mounting a wheel (not shown) in a known manner. The fork legs 12, 14 are connected at their upper ends by one or a pair of crowns 20 which is/are attached to a steerage tube 22. The steerage tube, in use, is rotatably connected to the frame of the cycle and has a handlebar assembly (not shown) fixedly mounted thereon in a conventional manner.

Each of the fork legs 12, 14 has generally the same structure and so the following description of one of said fork legs 14 can be considered as a description of the remaining fork leg 12. Referring also to FIG. 2, the fork leg 14 has an upper tube 14a which is telescopically received in a lower tube 14b. These tubes 14a, 14b can be orientated with the outer tube at the bottom (normally referred to as a “conventional fork”) as illustrated herein or with the outer tube at the top (referred to as an “upside down fork”), but this has no bearing on the following description. A bushing and seal arrangement 24 is provided inside an upper end portion of the lower tube 14b to slidably and sealingly engage with an outer surface of the upper tube 14a. Additionally, a bush 26 is located within the lower tube 14b to further facilitate movement of the upper tube 14a within the lower tube 14b.

A damper assembly cartridge, generally denoted as 28, is located within the upper and lower tubes 14a,b and is arranged to control the speed at which the fork leg 14 can compress and return (rebound) through the action of a piston moving within an oil filled chamber. The damper assembly cartridge 28 comprises a piston 30 mounted on a damper shaft 32 which is fixedly secured to an end cap 34 of the upper tube 14a. Consequently, the piston 30 is mounted in a fixed relationship with respect to the upper tube 14a for movement therewith.

The assembly 28 includes a cartridge tube 36 which is fixedly secured at its lower end to an end wall 14c of the lower tube 14b such that it moves therewith. The cartridge tube 36 has a bushing arrangement 37 within an end cap 40 thereof which slidably engages the damper shaft 32. The cartridge tube 36 encloses an oil filled chamber 38 within which the piston 30 is slidably and sealingly received. There is normally a small amount of clearance between the bushing arrangement 37 and the damper shaft which allows for the bleeding of air from the damper assembly 28 on assembly and in use. However, in some known arrangements, the bushing arrangement 37 may be sealed but includes a port (not shown) to enable air to be bled from the damper assembly 28.

The damper shaft 32 carries a spring 42 which biases the upper tube 14a of the fork 14 to normally extend generally outwardly from the lower tube 14b. The spring 42 is carried on the outside of the damper shaft 32 and is arranged such that it is compressed between the end cap 40 of the cartridge tube 36 and an underside of the upper tube end cap 34 when the fork leg 14 is compressed.

The piston 30 is a demand valve assembly as can be more readily seen in FIGS. 3 & 4. It comprises a ported shock piston 30 screw-threadedly secured to the damper shaft 32 by a piston bolt 44. The piston 30 has at least one compression port 46 which is open to the underside of the piston 30 but closed to the upper side by an arrangement of flexible steel, leaf spring valve members (shims) 48 known as the “compression shim stack”. The piston 30 also has at least one rebound port 50 which is open to the upper side of the piston 30 but closed to the underside by a further arrangement of flexible steel, leaf spring valve members 52 known as the “rebound shim stack”.

When the cycle suspension system receives a shock (bump force) through its wheels when travelling over rough terrain, for example, the fork leg 14 is compressed such that the piston 30 moves downwardly with respect to the cartridge tube 36 thereby increasing the pressure of oil in a lower part of the chamber 38. When the pressure of oil in the lower part of the chamber 38 increases above a certain level on a compression stroke of the piston 30, it causes the compression shims 48 to flex away from the upper side of the piston 30 thus enabling fluid communication between the upper and lower parts of the chamber 38 such that oil flows from the lower part of the chamber below the piston 30 to the upper part of the chamber 38 above the piston 30 via the compression port(s) 46. The increased oil pressure in the lower part of the chamber 38 also acts to maintain the rebound shims 52 in their normal closed position on the compression stroke of the piston 30. As the pressure of oil in the lower part of the chamber 38 increases further (increased bump force), the compression shims 48 will deflect even further from the upper side of the piston to allow increased oil flow through the compression port 46. As the oil pressure in the lower part of the chamber 38 decreases, as it may do during the compression stroke of the piston 30 and as it inevitably will do towards the end of said stroke, the compression shims 48 will begin to close thus restricting the flow of oil through the compression port 46. In this way, the compression shims 48 control the ‘demand’ for oil on the piston compression stroke.

During the piston compression stroke, the spring 42 compresses. When the force acting to compress the suspension system decreases to below a spring return force generated by the energy now stored in the spring 42, the suspension system rebounds, i.e. the piston 30 now moves upwardly with respect to the cartridge tube 36 on a rebound stroke towards its normal at rest position. On the rebound stroke, oil in the upper part of the chamber 38 is under greater pressure than oil in the lower part of the chamber 38. When the oil pressure in the upper part of the chamber 38 rises above a certain level, it causes the rebound shims 52 to bend away from the underside of the piston 30 thus enabling fluid communication between the upper and lower parts of the chamber 38 such that oil flows from the upper part of the chamber above the piston 30 to the lower part of the chamber 38 below the piston 30 via the rebound port(s) 50. When the spring compression is high after a large compression of the suspension system, the rebound shims 52 will open to a greater extent on the rebound stroke until the spring return force diminishes (towards full spring extension) when the rebound shims 52 begin to close. During the rebound stroke of the piston 30, the increased oil pressure in the upper part of the chamber 38 also acts to maintain the compression shims 48 in their normal closed position.

The upper and lower parts of the chamber 38 are in a “low speed” fluid communication via a free bleed port 44a comprising a bore extending centrally of the piston bolt 44 and a side port 32a in a lower portion of the damper shaft 32 adjacent to and just above the piston 30. Slidably mounted within a central bore of the damper shaft 32 and in sealing engagement therewith is a needle valve 82 which, when in a closed position, closes off the “low speed” flow such that oil is forced to pass through the “high speed” fluid circuits of the compression and rebound shim stacks 48, 52 on respective compression and rebound strokes of the piston 30.

The needle valve 82 is adjustable to occupy any position between an open position affording low speed fluid communication between the upper and lower parts of the chamber 38 and its closed position by means of an adjuster 84 which is externally accessible at the top of the fork leg 14. This adjuster 84 is commonly referred to as the “low speed rebound adjuster” despite the fact that, when open to any degree, it allows some oil flow to by-pass the high speed compression fluid circuit comprising the compression port(s) 46 and compression shim stack 48 on the compression stroke of the piston 30.

In a lower part of the cartridge tube 36 is located a static piston or valve unit normally referred to as the “base valve” assembly 86 that is in fluid communication with the lower part of the chamber 38 below the damper piston 30 and a reservoir 88 which fills the space between an outer surface of the cartridge tube 36 and inner surfaces of the upper and lower tubes 14a,b.

The base valve assembly 86 comprises a demand valve assembly 90 secured by a bolt 92 to a shaft 94. The shaft may be screw-threadedly engaged to a lower end cap 96 of the cartridge tube 36 or may be formed integrally therewith. The piston bolt 92 has an internal passage (adjuster port) 98 which affords fluid communication between the lower part of the chamber 38 below the damper piston 30 and a volume 100 below the demand valve assembly 90 via a side port 94a in the shaft 94 when a needle valve 102 located in the internal passage 98 of the bolt 92 is in an open position. The volume 100 is in fluid communication with the reservoir 88 via ports 104 in the wall of the cartridge tube 36. However, when the needle valve 102 is in a closed position, fluid flow through the adjuster port 98 of the bolt 92 is prevented thus preventing fluid flow by-passing the demand valve assembly 90. The position of the needle valve 102 between its open and closed position is adjustable by an adjuster 103 which is accessible externally at the bottom of the fork leg 14. This adjuster is known as the “low speed compression adjuster” for reasons which will become apparent from the following description.

The demand valve assembly 90 includes a static piston 106 fixedly secured within the lower part of the cartridge tube 36. The static piston 106 has at least one compression port 108 open to the lower part of the chamber 38 above said static piston 106 but which is closed on the underside of said piston 106 by a static piston compression shim stack 110. On a compression stroke of the damper piston 30, oil is displaced downwardly in the chamber 38 by ingress of the damper shaft 32 thus causing an increase in the pressure of oil in the lower part of the chamber 38 above the static piston 106. Displaced oil flows through the static piston 106 to the volume 100 and onward to the reservoir 88 through the adjuster port 98 and/or the compression port 108 (and compression shim stack 110). When the displaced oil is prevented from flowing through the adjuster port 98 by dint of the needle valve 102 being in its closed position, then oil pressure in the lower part of the chamber 38 must reach a certain level necessary to cause deflection of the compression shim stack 110 (demand valve) before fluid can flow to the volume 100 below the static piston 106.

On a rebound stroke of the damper piston 30, oil returning from the reservoir 88 via the volume 100 to the chamber 38 passes through a port 112 in the static piston 106 open to the volume 100 and a one way, sprung check valve 114 on the upper side of the static piston 106 which closes said port 112 on a compression stroke of the damper piston 30. The check valve 114 is configured as a very light shim stack so as not to unduly affect the returning oil flow. In this way, the actuation of the adjuster 103 to adjust the position of the needle valve 102 between its open and closed positions affects only the compression stroke damping characteristic of the damper assembly 28 in contrast with actuation of the rebound adjuster 84 which affects both the compression and rebound stroke damping characteristics.

Referring now to FIGS. 5 to 7, shown is an arrangement of a conventional rear damper unit for a cycle suspension system comprising a fully sealed oil circulating system which employs a pressurised compensator chamber to allow for displacement of oil on movement of a damper piston.

The rear damper unit, generally denoted as 228, can take many alternative forms so the following description of such a conventional unit should be taken as being merely illustrative of one such example. In the following description, like numerals to those employed in the description of a conventional front fork suspension system for a cycle with reference to FIGS. 1 to 4 but preceded by the numeral “2” will be utilised to denote like or similar parts.

The damper unit 228 has an eyelet 202 which is screw-threadedly secured to a damper shaft 232 and which houses an adjusting device 204 configured to cause a needle valve 282 located in an axial bore of the damper shaft 232 to move between open and closed positions. The eyelet 202 comprises a first mounting point at one end of the damper unit 228 enabling it to be mounted to a cycle (not shown) and is commonly referred to as the “shaft eyelet” or “rebound eyelet”.

The damper shaft 232 slidably and sealingly engages with a sealing arrangement known as a “seal block” 206 which is fixed to a damper unit body tube 236 by means of being screw-threadedly joined thereto or by circlips (not shown).

At an opposite end of the body tube 236 is located a further eyelet 208 which comprises a second mounting point by which the damper unit 228 can be mounted to a cycle and which is commonly referred to as the “compression eyelet”. Whilst this eyelet 208 is shown as being located at the upper end of the damper unit 228 as viewed in FIGS. 5 to 7, it will be understood that the damper unit 228 could be mounted to a cycle in a reverse orientation to that shown in the figures.

A return spring 242 is carried exteriorly of the body tube 236 and the damper shaft 232 and acts between end rings 228a,b to return the damper shaft 232 to its normal at rest position with respect to the body tube 236 after the damper unit 228 has been compressed by a bump force.

The body tube 236 defines an oil chamber 238 within which a damper piston 230 is slidably and sealingly received for movement within the chamber 238 in unison with the damper shaft 232 and rebound eyelet 202. The damper piston 230 is secured to the damper shaft 232 by a hollow piston bolt 244, an internal bore 244a of which is in fluid communication with the axial bore of the damper shaft 232 and a side port 232a in the damper shaft adjacent to and below the damper piston 230. The damper piston 230 includes respective compression and rebound shim stacks 248, 252 and compression and rebound ports 246, 250. The body tube 236 is secured to a housing 211 carrying the compression eyelet 208 such that it moves therewith when the damper unit 228 is compressed by a bump force received by wheels of the cycle.

Also secured to the compression eyelet housing 211 is a compensator chamber housing 215 defining a compensator chamber 217. A floating compensator piston 219 divides the compensator chamber 217 into an upper oil filled part 217a and a lower pressurised gas filled part 217b. An end cap 225 of the compensator housing 215 includes a gas valve 221 by which gas, commonly nitrogen, under pressure can be admitted to the lower part 217b of the compensator chamber 217 to pressurise it.

Extending through the compression eyelet housing 211 is an oil passageway 211a in fluid communication with the damper piston chamber 238 on one side and in fluid communication with the upper part 217a of the compensator chamber on the other side. Within the oil passageway 211a is located an adjuster valve assembly 286 for controlling oil flow through the passageway 211a.

When the adjusting device 204 comprising the low speed rebound adjuster for this damper unit arrangement is actuated to move the needle valve 282 to its open position, the damper piston chamber lower part (as viewed in the figures) is in direct fluid communication with the upper part of the chamber 238 via the damper shaft side port 232a, damper shaft axial bore and piston bolt bore 244a. Consequently, low speed oil flow is enabled on both the compression and rebound strokes of the damper piston 230 enabling at least some oil flow on these strokes to by-pass the high speed circuits comprising respectively the compression shim stack 248 and its port 246 and the rebound shim stack 252 and its port 250. However, when the needle valve 282 is in its closed position, the lower part of the chamber 238 is in fluid communication with the upper part of said chamber 238 only through the high speed fluid flow circuits on respective compression and rebound strokes thus operating in a similar manner to that described for the conventional damper piston arrangement described with reference to FIGS. 1 to 4.

The adjuster valve assembly 286 comprises a demand valve assembly 290 secured by a hollow bolt 292 to a shaft 294 which extends horizontally (as depicted in the figures) from a closure member 223. The shaft 294 may be screw-threadedly connected to the closure member 223 or formed integrally therewith. The piston bolt 292 has an axially extending bore affording fluid communication between that part of the passageway 211a adjacent to the damper chamber 238 and the upper part 217a of the compensator chamber 217 via a port 223a in the closure member 223 when a needle valve 2102 slidably mounted in the closure member 223 is in an open position. However, when said needle valve 2102 is in a closed position, fluid flow through the low speed circuit comprising the passageway 211a, the piston bolt bore and the closure member port 223a is prevented, thus preventing fluid flow by-passing the demand valve assembly 290. The position of the needle valve 2102 is adjustable to any position between its open and closed positions by means of manual actuation of an adjuster device 2103 accessible externally of the damper unit 228. The adjuster device 2103 comprises a low speed compression adjuster for the damper unit 228.

The demand valve assembly 290 comprises a static piston 2106 having at least one compression port open to the damper chamber side thereof and closed to the compensator chamber side by a compression shim stack 2110.

On a compression stroke of the damper piston 230, oil is displaced by ingress of the damper shaft 232 into the damper chamber 238 causing the damper piston 230 to pass through the oil in said chamber 238. The displaced oil passes to the upper part 217a of the compensator chamber via the passageway 211a. When the low speed compression adjuster device 2103 is in its closed position, oil can only flow to the compensator chamber upper part 217a via the static piston compression shim stack 2110 which regulates through flexing oil flow ‘demand’ in dependence on the pressure exerted thereon.

Oil returning to the damper chamber 238 on a rebound stroke of the damper piston 230 passes through a rebound port (not shown) in the static piston 2106 and a one way, sprung check valve 2114 on the upper side of the static piston 2106 which closes said rebound port on a compression stroke of the damper piston 230. The check valve 2114 is configured as a very light shim stack so as not to unduly affect the returning oil flow. In this way, the actuation of the adjuster 2103 to adjust the position of the needle valve 2102 between its open and closed positions affects only the compression stroke damping characteristic of the damper assembly 228 in contrast with actuation of the rebound adjuster 284 which affects both the compression and rebound stroke damping characteristics.

Referring now to FIGS. 8(a to d) and 9, shown is a first embodiment of a novel damper assembly in accordance with the invention which replaces the damper assemblies of conventional damper units such as those described with reference to FIGS. 1 to 4 and 5 to 7 respectively. Consequently, in the following description of the first embodiment of the novel arrangement of the present invention, like numerals to those employed in the description of the conventional damper unit depicted by FIGS. 1 to 4 but preceded by the numeral “3” will be employed herein to denote like or similar parts, but this is not to be taken as limiting the application of the novel damper assembly of the invention to specific vehicle types or suspension system types. However, the descriptions of the conventional damper assemblies with respect to FIGS. 1 to 4 & 5 to 7 do comprise content of the damper assembly of the invention to the extent that they describe those parts of the damper assembly of the invention omitted from the following description for the sake of conciseness.

The damper assembly, generally denoted as 328, comprises a housing 336 defining a chamber 338 in which a composite piston assembly 330 is slidably and sealingly received for reciprocal movement through a fluid such as oil contained therein in response to bump forces received through the wheels of an associated vehicle (not shown). The housing 336 which may comprise a cartridge construction or tube body as will be familiar to a skilled artisan (and as described with reference to FIGS. 1 to 4 & 5 to 7 respectively) is shown as a truncated section without end caps but this is merely for ease of illustration. Also not shown are other common elements of a damper assembly such as a return spring but these are also omitted as already indicated in the foregoing for the sake of conciseness.

The composite piston assembly 330 comprises first and second spaced apart piston elements 330a,b mounted centrally of a piston bolt 344 which screw-threadedly engages an end of a damper shaft 332 thereby securing said piston elements 330a,b in a fixed spatial relationship with respect to each other and the damper shaft 332. Consequently, movement of the damper shaft 332 in response to bump forces received through wheels of an associated vehicle causes movement of the piston assembly 330 through the fluid in the chamber 338. In the following description, a movement of the piston assembly 330 in a downward direction (when viewed in FIGS. 8a-d) will be taken to comprise a compression stroke of said assembly and, conversely, movement in an upward direction will be taken as comprising a rebound stroke.

The piston elements 330a,b divide the chamber 338 into a first volume 338a below the first piston element 330a or in advance of said element 330a on a compression stroke, a second chamber 338b comprising the fixed space between said elements 330a,b and a third volume 338c above said second piston element 330c or behind it on a compression stroke.

The first piston element 330a has at least one first compression port 346 which is open on the underside of said piston element 330a to the first volume 338a but is closed on the upper side thereof by a first compression shim stack 348. The first compression port(s) 346 and the first compression shim stack 348 comprise a first compression demand valve thereby defining a first compression fluid flow circuit that affords fluid communication from the first volume 338a to the second volume 338b on a compression stroke of the piston assembly 330.

Similarly, the second piston element 330b has at least one second compression port 346′ which is open on the underside of said piston element 330b to the second volume 338b but is closed on the upper side thereof by a second compression shim stack 348′. The second compression port(s) 346′ and the second compression shim stack 348′ comprise a second compression demand valve thereby defining a second compression fluid flow circuit that affords fluid communication from the second volume 338b to the third volume 338c on a compression stroke of the piston assembly 330. It can be seen therefore that the second compression fluid flow circuit is in series with the first compression fluid flow circuit to afford fluid communication from the first volume 338a to the third volume 338c, via the second volume 338b, on a compression stroke.

The first and second compression shim stacks 348, 348′ each comprise an arrangement of flexible, leaf spring members as will be familiar to a skilled artisan. Whilst the shims may be formed from spring steel as is common, it will be understood that said shims can be formed from any suitable flexible, sheet-form material. The thicknesses, diameters and numbers of the shims comprising said stacks 348, 348′ determine the resistances to fluid flow of said stacks. In the damper assembly of the present invention, the first compression shim stack 348 is arranged to have a greater resistance to flow than the second compression shim stack. Preferably, the first compression shim stack 348 has a considerably greater resistance to fluid flow in an order of magnitude to the flow resistance of the second compression shim stack 348′.

As illustrated particularly in FIG. 8a, when a wheel of an associated vehicle receives a bump shock causing compression of the damper assembly 328, the piston assembly 330 moves downwardly (as viewed in the figure) on a compression stroke (denoted by arrow C in the figure) thereby compressing fluid in the first volume 338a and causing an increase in the pressure of said fluid. When the pressure level of the fluid in the first volume exceeds a certain level determined by the flow resistance characteristic of the first compression shim stack 348, the fluid pressure exerted on said shim stack 348 through the compression port (s) 346 causes said shim stack 348 to flex away from the upper surface of the first piston element 330a thereby allowing fluid to flow to the second volume 330c and onward, via the second compression fluid flow circuit (second compression port(s) 346′ and second compression shim stack 348′), to the third volume 330c (as indicated by bold arrowed lines in the figure).

For large bump forces, the pressure level in the first volume 338a will increase rapidly thereby causing said shim stack 348 to flex to a larger degree allowing a greater rate of fluid flow from the first volume 338a to the second volume 338b and onward to the third volume 338c. The first and second shim stacks 348, 348′ between them determine a damping characteristic for the piston assembly 330 on a compression stroke although the first compression shim stack 348 dominates this characteristic.

The second piston element 330b has at least one first rebound port 350 which is open on the upper side of said piston element 330b to the third volume 338c but is closed on the underside thereof by a first rebound shim stack 352. The first rebound port(s) 350 and the first rebound shim stack 352 comprise a first rebound demand valve thereby defining a first rebound fluid flow circuit that affords fluid communication from the third volume 338c to the second volume 338b on a rebound stroke of the piston assembly 330.

Similarly, the first piston element 330a has at least one second rebound port 350′ which is open on the upper side of said piston element 330a to the second volume 338b but is closed on the underside thereof by a second rebound shim stack 352′. The second rebound port(s) 350′ and the second rebound shim stack 352′ comprise a second rebound demand valve thereby defining a second rebound fluid flow circuit that affords fluid communication from the second volume 338b to the first volume 338a on a rebound stroke of the piston assembly 330. It can be seen therefore that the second rebound fluid flow circuit is in series with the first rebound fluid flow circuit to afford fluid communication from the third volume 338c to the first volume 338a, via the second volume 338b, on a rebound stroke. The first rebound shim stack 352 is arranged to have a flow resistance that is greater than that of the second rebound shim stack 352′.

As illustrated particularly in FIG. 8b, on a rebound stroke (as denoted by arrow R in the figure) of the piston assembly 330, fluid pressure in the third volume 330c above the second piston element 330b increases. Once the pressure level has increased above a certain level as determined by the flow resistances of the first and second rebound shim stacks 352, 352′, fluid flows in accordance with demand from the third volume 330c to the second volume 330b via the first rebound fluid flow circuit (comprising the first rebound port(s) 350 and the first rebound compression shim stack 352) and from the second volume 330b to the first volume 330a via the second rebound fluid flow circuit (as indicated by bold arrowed lines in the figure).

The piston bolt 344 has a blind bore 344a extending axially from its point of connection to the damper shaft 332 to side ports 344b thereof which open into the second volume 338b. The bore 344a of the piston bolt 344 affords fluid communication between the second volume 338b and the third volume 338c via an axial bore 332b of the damper shaft and a side port 332a thereof when a needle valve 382 mounted in the axial bore 332b is in an open position. The fluid flow circuit thus constituted comprises a by-pass fluid flow circuit of the damper assembly 328. It will be observed that this fluid flow circuit is parallel to both the second compression fluid flow circuit and the first rebound fluid flow circuit allowing fluid to by-pass these circuits on respective compression and rebound strokes of the piston assembly 330 when the needle valve is in its open position (as illustrated in FIGS. 8c & d). It will also be observed that the by-pass fluid flow circuit does not by-pass the first compression fluid flow circuit or the second rebound fluid flow circuit.

The needle valve has an externally accessible adjuster 384 associated therewith which enables the position of the valve to be manually operated to occupy a position anywhere between its open and closed positions. This adjustment of the degree to which the valve 382 is open comprises the low speed rebound adjustment of the damper assembly 328.

As will be apparent from a comparison of the operation of the damper assembly 328 as illustrated in FIG. 8a with that of FIG. 8c, it will be observed that, on a compression stroke with the needle valve 382 open to some degree (FIG. 8c), some of the resultant compression stroke fluid flow flows through the piston bolt bore 344a thereby by-passing the second compression fluid flow circuit. However, all fluid flow on the compression stroke must still flow through said first compression fluid flow circuit in contrast with the conventional damper assembly arrangements described herein. By dint of the fact that the first compression shim stack 348 is arranged to have a considerably larger flow resistance than the second compression shim stack 348′, the range of the compression damping characteristic defined by these shim stacks in series is small since it is the considerably lower flow resistance compression fluid flow circuit that is progressively “switched” out of the compression fluid flow circuit as the valve 382 is progressively opened.

Comparing the operation of the damper assembly 328 as illustrated by FIGS. 8b and 8d respectively on a rebound stroke, it will be observed that it is the first rebound fluid flow circuit having the larger flow resistance characteristic that is progressively switched out of the rebound fluid flow circuit as the valve 382 is progressively opened. As such, for a given amount by which the valve 382 is opened, this constitutes a proportionally greater relative adjustment in the rebound damping characteristic of the damper assembly 328 than the corresponding adjustment to the compression damping characteristic resulting from said opening of the valve 382. In fact, the shim stack of the second compression fluid flow circuit may be so “light”, i.e. have such a low resistance to fluid flow, that there is a barely perceptible change to the compression stroke damping characteristic for a given adjustment of the valve 382. In other words, the compression damping characteristic which is dominated by the first compression fluid flow circuit remains almost constant despite adjustment of the valve 382 whereas the rebound damping characteristic varies over a wide range in response to adjustment of said valve 382.

Consequently, the damper assembly of the first embodiment of the present invention is such that all fluid flow on a compression stroke must pass through at least one compression demand valve irrespective of any adjustment of the low speed rebound adjuster. Also, the range of adjustment of the rebound damping characteristic is so large that it negates the need to rearrange and reassemble the shim stacks for different terrain and riding styles etc.

The compression and rebound shim stacks 348, 348′, 352, 352′ are also arranged such that the sum of the flow resistances of the first and second compression shim stacks 348, 348′ is greater than the sum of the flow resistances of the first and second rebound shim stacks 352, 352′.

Referring now to FIGS. 10(a to d), there is shown a second embodiment of a novel damper assembly in accordance with the invention. In the following description of the second embodiment of the novel damper assembly arrangement of the present invention, like numerals to those employed in the description of the first embodiment depicted by FIGS. 8(a to d) and 9 but preceded by the numeral “4” will be employed herein to denote like parts.

The damper assembly, generally denoted as 428, comprises a housing 436 defining a chamber 438 in which a composite piston assembly 430 is slidably and sealingly received for reciprocal movement through a fluid such as oil contained therein in response to bump forces received through the wheels of an associated vehicle (not shown). The housing 436 is shown as a truncated section without end caps but this is merely for ease of illustration. Also not shown are other common elements of a damper assembly such as a return spring but these are also omitted for the sake of conciseness.

The composite piston assembly 430 comprises first and second spaced apart piston elements 430a,b mounted centrally of a piston bolt 444 which screw-threadedly engages an end of a damper shaft 432 thereby securing said piston elements 430a,b in a fixed spatial relationship with respect to each other and the damper shaft 432.

The piston elements 430a, b divide the chamber 438 into a first volume 438a below the first piston element 430a or in advance of said element 430a on a compression stroke, a second chamber 438b comprising the fixed space between said elements 430a,b and a third volume 438c above said second piston element 430b or behind it on a compression stroke.

The first and second piston elements 430a,b have structures generally identical to those of the first and second piston elements respectively of the first embodiment of the damper assembly in accordance with the invention. In contrast with said first embodiment, however, the first compression shim stack 448 located on the first piston element 430 has a resistance to flow characteristic which is substantially less than that of the second compression shim stack 448′ located on the second piston element 430b and similarly the first rebound shim stack 452 located on the second piston element 430b has a resistance to flow characteristic which is less than the resistance to flow of the second rebound shim stack 452′ located on the first piston element 430a.

In a further departure from the first embodiment, the bore 444a in the piston bolt 444 extends axially from a head of the bolt adjacent to the lower side of the first piston element 430a to side ports 444b thereof which open into the second volume 438b. This lower part (as viewed in FIGS. 10a-d) of the piston bolt bore 444b affords fluid communication between the first volume 438a and the second volume 438b. The bore 444a also extends upwardly to its point of connection to the damper shaft 432 but this upper part the bore 444 is sealed by a needle valve 482 mounted in the axial bore 432b which can be operated to open or close the fluid communication circuit comprising the lower part of the bore 444a and side ports 444b. The fluid flow circuit thus constituted comprises a by-pass fluid flow circuit of the damper assembly 428. It will be observed that this fluid flow circuit is parallel to both the first compression fluid flow circuit and the second rebound fluid flow circuit which is the converse of the arrangement of the first embodiment.

The needle valve 482 has an externally accessible adjuster 484 associated therewith which enables the position of the valve to be manually operated to occupy a position anywhere between its open and closed positions. As with the first embodiment, the adjustment of the degree to which the valve 482 is open comprises the rebound adjustment of the damper assembly 428.

As will be apparent from a comparison of the operation of the damper assembly 428 as illustrated in FIG. 10a with that of FIG. 10c, it will be observed that, on a compression stroke with the needle valve 482 open to some degree (FIG. 10c), some of the resultant compression stroke fluid flow flows through the piston bolt bore 444a thereby by-passing the first compression fluid through the piston bolt bore 444a thereby by-passing the first compression fluid flow circuit. However, all fluid flow on the compression stroke must still flow through said second compression fluid flow circuit which has the greater resistance to flow (is the heavier) of the two compression fluid flow circuits.

Comparing the operation of the damper assembly 428 as illustrated by FIGS. 10b and 10d respectively on a rebound stroke, it will be observed that it is the second rebound fluid flow circuit having the larger flow resistance characteristic that is progressively switched out of the rebound fluid flow circuit as the valve 482 is progressively opened. As such, for a given amount by which the valve 482 is opened, this constitutes a proportionally greater relative adjustment in the rebound damping characteristic of the damper assembly 428 than the corresponding adjustment to the compression damping characteristic resulting from said opening of the valve 482. In fact, the shim stack of the first compression fluid flow circuit may be so “light”, i.e. have such a low resistance to fluid flow, that there is a barely perceptible change to the compression stroke damping characteristic for a given adjustment of the valve 482. In other words, the compression damping characteristic which is dominated by the second compression fluid flow circuit remains almost constant despite adjustment of the valve 482 whereas the rebound damping characteristic varies over a wide range in response to adjustment of said valve 482.

It will be appreciated from the foregoing that the arrangement of the damper assembly in accordance with the second embodiment of the present invention is such that it can be considered as being a reversal of the arrangement of the first embodiment, but that both of said arrangements operate in essentially the same manner.

Where the damper assembly of either of the first or second embodiments of the present invention replaces the damper assembly in a damper unit of the types described herein with respect to FIGS. 1 to 4 and 5 to 7 in which the damper chamber is in fluid communication with a reservoir or compensator chamber via a further one-way demand valve assembly constituting a further (third) compression fluid flow circuit, the third compression fluid flow circuit is arranged to have a greater resistance to fluid flow that the first or second compression fluid flow circuits. In parallel to this third compression fluid flow circuit is a fluid flow control means adapted to open a further (second) by-pass circuit which by-passes the third compression fluid flow circuit. When the second by-pass circuit is open, the third compression fluid flow circuit is by-passed and the one of the first or second compression fluid flow circuits having the greater resistance to flow dominates the compression damping characteristic of the damper unit. However, when the second by-pass circuit is closed, the compression fluid flow must also overcome the greater flow resistance of the third fluid flow circuit which now dominates the compressing damping characteristic of the damper unit. Adjustment of the degree to which the second by-pass circuit is open constitutes a compression adjustment for the damper unit allowing the compression damping characteristic to be adjusted generally in the range of the flow resistance of the one of the first and second compression fluid flow circuits having the greater resistance to flow to the sum of the flow resistances of such compression fluid flow circuit and the third compression fluid flow circuits. On a rebound stroke, the further demand valve offers little or no flow resistance to returning fluid flow via a light one-way fluid flow device.

Whilst the present invention has been described herein with reference to cycles, it will be understood that a damper unit in accordance with the invention could be utilised in the suspension system of any wheeled, tracked or sledded vehicle that employs an oil filled damper unit.

In summary, the present invention concerns a damper unit for a vehicle suspension system of the type that employs demand valves to meter fluid flow on compression and rebound strokes to determine the compression and rebound damping responses. The damper unit employs two compression stroke demand valves in series, two rebound stroke demand valves in series and a by-pass passage in parallel with both a lighter one of the compression stroke demand valves and a heavier one of the rebound stroke demand valves. A by-pass valve allows the amount of fluid by-passing the lighter compression stroke demand valve and the heavier rebound stroke demand valve on respective compression and rebound strokes to be adjusted All fluid flow on the compression stroke is metered by at least the heavier compression stroke demand valve. The flow resistances of the compression and rebound stroke demand valves are chosen such that a small adjustment of the by-pass valve causes a significantly greater relative change in the rebound damping response of the damper unit than is caused in the compression damping response. In fact, the corresponding change in the compression damping response may be barely perceptible. The damper unit is intended to be used in a suspension system of a bicycle or motorcycle but is applicable to any vehicle having a suspended chassis.

The present invention enables a blend to be achieved between a lightest necessary (desirable) rebound shim stack and a heaviest necessary rebound shim stack by adjusting the by-pass port. On compression, the blend would normally be between the fluid flow on the main piston assembly and the compression flow on the static, third compression shim stack acting on displaced oil.

1-32. (canceled)

33. A damper for a vehicle suspension system comprising a chamber in which a piston assembly is movable, the piston assembly dividing the chamber into first, second and third volumes; the damper including a first compression fluid flow circuit affording fluid communication from the first volume to the second volume on a compression stroke of the piston assembly, a second compression fluid flow circuit in series with said first fluid flow circuit, said second compression fluid flow circuit affording fluid communication from the second volume to the third volume on said compression stroke, wherein one of said first and second compression fluid flow circuits has a flow resistance greater than that of the other of said first and second compression fluid flow circuits.

34. A damper as claimed in claim 33, wherein the flow resistance of the first compression fluid flow circuit is greater than the flow resistance of the second compression fluid flow circuit.

35. A damper as claimed in claim 34, wherein the flow resistance of the first compression fluid flow circuit is substantially greater than the flow resistance of the second compression fluid flow circuit.

36. A damper as claimed in claim 33, wherein the flow resistance of the second compression fluid flow circuit is greater than the flow resistance of the first compression fluid flow circuit.

37. A damper as claimed in claim 33 including a first rebound fluid flow circuit affording fluid communication from the third volume to the second volume on a rebound stroke of the piston assembly and a second rebound fluid flow circuit in series with said first rebound fluid flow circuit, said second rebound fluid flow circuit affording fluid communication from the second volume to the first volume on said rebound stroke.

38. A damper as claimed in claim 37, wherein the first rebound fluid flow circuit has a flow resistance greater than that of the second rebound fluid flow circuit.

39. A damper as claimed in claim 37, wherein the second rebound fluid flow circuit has a flow resistance greater than that of the first rebound fluid flow circuit.

40. A damper as claimed in claim 37 including a by-pass fluid flow circuit in parallel with a lighter of the two compression fluid flow circuits and a heavier of the two rebound fluid flow circuits, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the lighter of the two compression fluid flow circuits and the heavier of the two rebound fluid flow circuits on respective compression and rebound strokes of the piston assembly.

41. A damper as claimed in claim 37 including a by-pass fluid flow circuit in parallel with both the second compression fluid flow circuit and the first rebound fluid flow circuit where said second compression fluid flow circuit has a flow resistance less than the first compression fluid flow circuit and said first rebound fluid flow circuit has a flow resistance greater than the second rebound fluid flow circuit, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the second compression fluid flow circuit and the first rebound fluid flow circuit on respective compression and rebound strokes of the piston assembly.

42. A damper as claimed in claim 37 including a by-pass fluid flow circuit in parallel with both the first compression fluid flow circuit and the second rebound fluid flow circuit where said first compression fluid flow circuit has a flow resistance less than that of the second compression fluid flow circuit and said second rebound fluid flow circuit has a flow resistance greater than that of the first rebound fluid flow circuit, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the first compression fluid flow circuit and the second rebound fluid flow circuit on respective compression and rebound strokes of the piston assembly.

43. A damper as claimed in claim 39, wherein the fluid flow control means is adjustable to occupy any position between open and closed positions thereof in order to vary the portion of the fluid flow allowed to flow through the by-pass fluid flow circuit.

44. A damper as claimed in claim 33, wherein the first and second compression fluid flow circuits respectively comprise first and second compression stroke demand valves.

45. A damper as claimed in claim 37, wherein the first and second rebound fluid flow circuits respectively comprise first and second rebound stroke demand valves.

46. A damper as claimed in claim 37, wherein the by-pass fluid flow circuit comprises a passage through a piston or mounting bolt of a piston element.

47. A shock absorber for a vehicle comprising a chamber, a piston assembly movable in the chamber, said piston assembly dividing the chamber into first, second and third volumes, a first compression fluid flow circuit affording fluid communication from the first volume to the second volume on a compression stroke of the piston assembly, and a second compression fluid flow circuit in series with said first fluid flow circuit, said second compression fluid flow circuit affording fluid communication from the second volume to the third volume on said compression stroke, wherein one of said first and second compression fluid flow circuits has a flow resistance greater than the other of said first and second compression fluid flow circuits.

48. A shock absorber as claimed in claim 47, wherein the flow resistance of the first compression fluid flow circuit is greater than the flow resistance of the second compression fluid flow circuit.

49. A shock absorber as claimed in claim 47, wherein the flow resistance of the second compression fluid flow circuit is greater than the flow resistance of the first compression fluid flow circuit.

50. A shock absorber as claimed in claim 47 including a first rebound fluid flow circuit affording fluid communication from the third volume to the second volume on a rebound stroke of the piston and a second rebound fluid flow circuit in series with said first rebound fluid flow circuit, said second rebound fluid flow circuit affording fluid communication from the second volume to the first volume on said rebound stroke.

51. A shock absorber as claimed in claim 50, wherein the first rebound fluid flow circuit has a flow resistance greater than that of the second rebound fluid flow circuit.

52. A shock absorber as claimed in claim 50, wherein the second rebound fluid flow circuit has a flow resistance greater than that of the first rebound fluid flow circuit.

53. A shock absorber as claimed in claim 50 including a by-pass fluid flow circuit in parallel with a lighter of the two compression fluid flow circuits and a heavier of the two rebound fluid flow circuits, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the lighter of the two compression fluid flow circuits and the heavier of the two rebound fluid flow circuits on respective compression and rebound strokes of the piston assembly.

54. A shock absorber as claimed in claim 50 including a by-pass fluid flow circuit in parallel with both the second compression fluid flow circuit and the first rebound fluid flow circuit where said second compression fluid flow circuit has a flow resistance less than that of the first compression fluid flow circuit and said first rebound fluid flow circuit has a flow resistance greater than that of the second rebound fluid flow circuit, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the second compression fluid flow circuit and the first rebound fluid flow circuit on respective compression and rebound strokes of the piston.

55. A shock absorber as claimed in claim 50 including a by-pass fluid flow circuit in parallel with both the first compression fluid flow circuit and the second rebound fluid flow circuit where said first compression fluid flow circuit has a flow resistance less than that of the second compression fluid flow circuit and said second rebound fluid flow circuit has a flow resistance greater than that of the first rebound fluid flow circuit, said by-pass fluid flow circuit including fluid flow control means that is operable to open or close said by-pass fluid flow circuit such that, when the fluid flow control means is operated to be open, the by-pass fluid flow circuit enables a portion of the fluid flow to by-pass the first compression fluid flow circuit and the second rebound fluid flow circuit on respective compression and rebound strokes of the piston assembly.

56. A shock absorber as claimed in claim 53, wherein the fluid flow control means is adjustable to occupy any position between open and closed positions thereof in order to vary the portion of the fluid flow allowed to flow through the by-pass fluid flow circuit on compression and rebound strokes of the piston assembly.

57. A suspension system for a vehicle comprising a shock absorber as claimed in claim 47 wherein the shock absorber is mounted to a component of a vehicle.

58. A suspension system as claimed in claim 57, wherein the vehicle component comprises a fork leg of a front fork assembly of a cycle.

59. A front fork assembly for a cycle including a damper as claimed in claim 33 in at least one fork leg thereof.

60. A cycle including a front fork assembly as claimed in claim 59.
